(19) United States
(12) Patent Application Publication
(10) Pub. No.: US 2024/0399251 A1
(43) Pub. Date: Dec. 5, 2024

(54) PROGRAM, METHOD, AND SYSTEM

(71) Applicant: CYGAMES, INC., Tokyo (JP)

(72) Inventors: Yuichiro Sato, Tokyo (JP); Takafumi Goto, Tokyo (JP); Yuki Okabe, Tokyo (JP); Junya Kumada, Tokyo (JP); Yingnan Liu, Tokyo (JP); Takafumi Ueno, Tokyo (JP); Yuki Shibata, Tokyo (JP); Shigeyoshi Mori, Tokyo (JP); Takashi Fujita, Tokyo (JP)

(73) Assignee: CYGAMES, INC., Tokyo (JP)

(21) Appl. No.: 18/802,829

(22) Filed: Aug. 13, 2024

Related U.S. Application Data
(63) Continuation of application No. PCT/JP2023/004372, filed on Feb. 9, 2023.

(30) Foreign Application Priority Data
Feb. 14, 2022 (JP) 2022-020503

(51) Int. Cl. A63F 13/533; A63F 13/52; A63F 13/537; A63F 13/58; A63F 13/822

(52) U.S. Cl. CPC A63F 13/533; A63F 13/52; A63F 13/537; A63F 13/822; A63F 13/58

(57) ABSTRACT

The present disclosure relates to a program for instructing a computer to perform: before the start of a battle game, accepting selection of a plurality of attributes of a game media to be included in a deck used in the battle game, the selection being made by a user, administering the deck such that, for each of the plurality of attributes selected by the user, the number of game media associated with that attribute becomes equal to or larger than a minimum number predetermined for each attribute, and displaying the plurality of attributes selected by the user and the plurality of attributes of the predetermined number of game media included in the deck used by an opponent that the user plays against.

### TECHNICAL FIELD

The present disclosure relates to a program, a method, and a system.

### BACKGROUND ART

Conventionally, there is a known technique of providing, to a user, a battle game that uses a deck that includes a specified number of game media (for example, digital cards) selected from among multiple game media each associated with an attribute.

### CITATION LIST

### Patent Literature

### [PTL 1]

Japanese Patent No. 6804675

### SUMMARY OF INVENTION

### Technical Problem

In a typical battle game such as the one described above, a limit is sometimes imposed so that it is necessary to build a deck by using game media associated with a single attribute. Thus, there is room for improving the strategy concerning the attribute.

One of the problems addressed by the present disclosure is to provide a program, a method, and a system capable of providing a battle game with improved strategies concerning attributes.

### Solution to Problem

According to one example of the present disclosure, there is provided a program for instructing a computer to provide, to a user, a battle game that uses a deck including a specified number of game media selected from among a plurality of game media each associated with an attribute, the program instructing the computer to perform: before the start of the battle game, accepting selection of a plurality of attributes of the game media to be included in the deck used in the battle game, the selection being made by the user; administering the deck such that, for each of the plurality of attributes selected by the user, the number of game media associated with that attribute becomes equal to or larger than a minimum number predetermined for each attribute; and displaying the plurality of attributes selected by the user and the plurality of attributes of the predetermined number of game media included in the deck used by an opponent that the user plays against.

According to another example of the present disclosure, there is provided a method for providing, to a user, a battle game that uses a deck including a specified number of game media selected from among a plurality of game media each associated with an attribute, the method including: before the start of the battle game, accepting selection of a plurality of attributes of the game media to be included in the deck used in the battle game, the selection being made by the user; administering the deck such that, for each of the plurality of attributes selected by the user, the number of game media associated with that attribute becomes equal to or larger than a minimum number predetermined for each attribute; and displaying the plurality of attributes selected by the user and the plurality of attributes of the predetermined number of game media included in the deck used by an opponent that the user plays against.

According to another example of the present disclosure, there is provided a system for providing, to a user, a battle game that uses a deck including a specified number of game media selected from among a plurality of game media each associated with an attribute, the system including: an accepting processing unit that accepts, before the start of the battle game, selection of a plurality of attributes of the game media to be included in the deck used in the battle game, the selection being made by the user; an administration processing unit that administers the deck such that, for each of the plurality of attributes selected by the user, the number of game media associated with that attribute becomes equal to or larger than a minimum number predetermined for each attribute; and a display processing unit that displays the plurality of attributes selected by the user and the plurality of attributes of the predetermined number of game media included in the deck used by an opponent that the user plays against.

### BRIEF DESCRIPTION OF DRAWINGS

FIG. 1 is an exemplary and schematic diagram illustrating the structure of a system according to an embodiment.

FIG. 2 is an exemplary and schematic block diagram illustrating the functional structure of a terminal device according to an embodiment.

FIG. 3 is an exemplary and schematic sequence diagram illustrating the flow of a process performed by a terminal device and a server device according to an embodiment.

FIG. 4 is an exemplary and schematic flowchart illustrating the flow of the deck-building process performed by the terminal device according to an embodiment.

FIG. 5 is an exemplary and schematic diagram illustrating one example of a class select screen according to an embodiment.

FIG. 6 is an exemplary and schematic diagram illustrating one example of a deck building screen according to an embodiment.

FIG. 7 is an exemplary and schematic diagram illustrating one example of a switch confirmation image according to an embodiment.

FIG. 8 is an exemplary and schematic diagram illustrating a deck building screen according to an embodiment in which the main class and the sub class are switched from the example illustrated in FIG. 6.

FIG. 9 is an exemplary and schematic diagram illustrating one example of a save confirmation image according to an embodiment.

FIG. 10 is an exemplary and schematic diagram illustrating one example of a save alert image according to an embodiment.

FIG. 11 is an exemplary and schematic diagram illustrating one example of a save alert image according to an embodiment different from the one illustrated in FIG. 10.

FIG. 12 is an exemplary and schematic diagram illustrating one example of a save alert image according to an embodiment different from the ones illustrated in FIGS. 10 and 11.

FIG. 13 is an exemplary and schematic diagram illustrating one example of a save alert image according to an embodiment different from the ones illustrated in FIGS. 10 to 12.

FIG. 14 is an exemplary and schematic diagram illustrating one example of a save alert image according to an embodiment different from the ones illustrated in FIGS. 10 to 13.

FIG. 15 is an exemplary and schematic diagram illustrating one example of a battle start screen according to an embodiment.

FIG. 16 is an exemplary and schematic diagram illustrating one example of a battle start screen according to an embodiment different from the one illustrated in FIG. 15.

FIG. 17 is an exemplary and schematic diagram illustrating one example of a battle start screen according to an embodiment different from the ones illustrated in FIGS. 15 and 16.

FIG. 18 is an exemplary and schematic diagram illustrating one example of a battle screen according to an embodiment.

FIG. 19 is an exemplary and schematic diagram illustrating one example of a battle screen according to an embodiment different from the one illustrated in FIG. 18.

FIG. 20 is an exemplary and schematic diagram illustrating one example of a battle screen according to an embodiment different from the ones illustrated in FIGS. 18 and 19.

FIG. 21 is an exemplary and schematic diagram illustrating one example of a pause screen according to an embodiment.

FIG. 22 is an exemplary and schematic block diagram illustrating one example of the hardware configuration of an information processing apparatus constituting a terminal device and a server device according to an embodiment.

### DESCRIPTION OF EMBODIMENTS

Hereinafter, embodiments of a program, a method, and a system according to the present disclosure are described with reference to the drawings. The features of the embodiments and the actions and effects brought about by these features described below are merely exemplary and are not limited by the contents of the disclosure below.

Furthermore, ordinal numbers, such as “first” and “second”, are used in the description below as necessary for the convenience of differentiation, and these ordinal numbers do not indicate any particular order of priority.

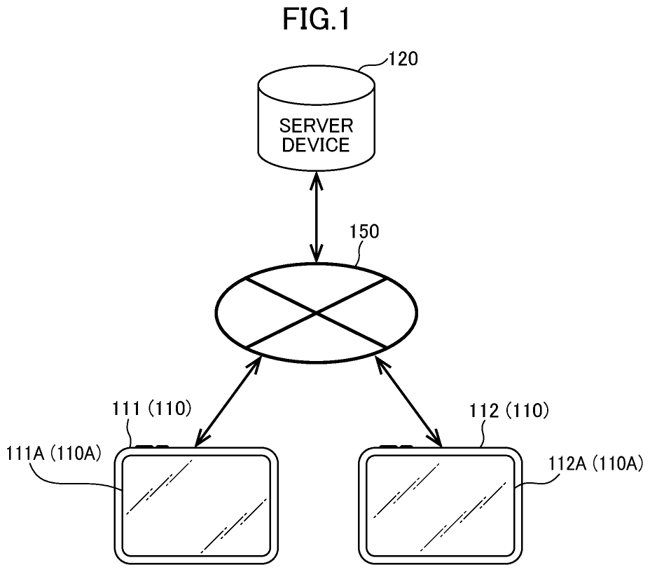

FIG. 1 is an exemplary and schematic diagram illustrating the structure of a system according to an embodiment.

As illustrated in FIG. 1, the system according to an embodiment includes multiple terminal devices 110 each including a display 110A having a touch panel, and a server device 120. The terminal devices 110 and the server device 120 are communicably connected with one another via a network 150 such as the Internet.

The structure illustrated in FIG. 1 is merely exemplary and does not limit the technical idea of the present disclosure. For example, in FIG. 1, terminal devices 111 and 112 configured as tablet computers respectively equipped with displays 111A and 112A are illustrated as examples of the terminal devices 110 that include the displays 110A. Alternatively, there may be three or more terminal devices 110, and the terminal devices 110 may be configured as electronic appliances other than tablet computers as long as they have the same structure as typical computers (specific examples thereof are described below with reference to FIG. 22).

In this embodiment, because of such a structure, the users of the terminal devices 110 can play a battle game via the network 150. For example, the battle game in this embodiment uses a deck that includes a specified number of cards selected from among, for example, digital cards (hereinafter simply referred to as “cards”) serving as game media each associated with an attribute (hereinafter, referred to as “class”).

For example, in this embodiment, each of the users of the terminal devices 110 gains possession of cards, which are provided by the administrator of the battle game, by digitally acquiring the cards such as by a lottery, builds a deck by selecting a specified number of cards from among the cards in the user's possession by taking the class into consideration, and plays a battle game with other users via the server device 120 by using the built deck.

Furthermore, in this embodiment, for example, the server device 120 records player information regarding the users (players) playing a battle game for each of the users participating in that battle game. The player information is, for example, information regarding the cards in the player's possession and information regarding a deck that a player has built in the past. In addition, the server device 120 updates the recorded player information and controls the progress of the battle game on the basis of the information output from the terminal devices 110 in response to the users' operations.

It should be noted here that various studies have been made on the aforementioned technology of providing, to the users, a battle game that uses a deck that includes a specified number of cards selected from among multiple cards each associated with a class. In such a typical battle game, a limit is sometimes imposed that requires that a deck be built by using game media associated with just one class. Thus, there is room for improving the strategy concerning the class.

In this embodiment, the features described in detail below make it possible to provide a battle game with further improved strategies concerning the class by enabling a battle game that uses a deck built to include cards of multiple classes under the condition that, for each of the classes, the number (minimum number) of cards that must at least be included in the deck is predetermined.

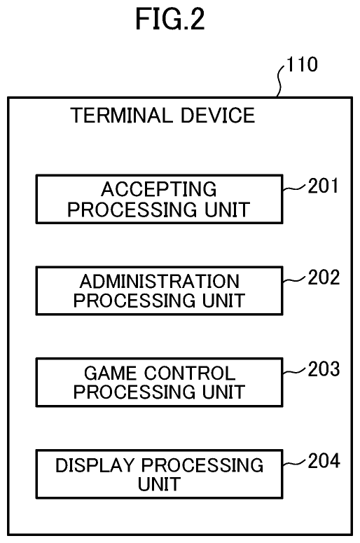

FIG. 2 is an exemplary and schematic block diagram illustrating the functional structure of a terminal device 110 according to an embodiment.

As illustrated in FIG. 2, the terminal device 110 includes an accepting processing unit 201, an administration processing unit 202, a game control processing unit 203, and a display processing unit 204.

The accepting processing unit 201 accepts inputs of various operations by the user using the terminal device 110. For example, the accepting processing unit 201 accepts, before the start of the battle game, selection of classes of the cards to be included in the deck used in the battle game, and accepts selection of the cards to be included in the deck after selection of the classes.

The administration processing unit 202 administers the deck built according to the operation by the user. The specific contents of the administration performed by the administration processing unit 202 are not described here but will be described in detail later.

The game control processing unit 203 controls the progress of the battle game in cooperation with the server device 120 via communication. The display processing unit 204 controls the output of the images related to the battle game to the display 110A.

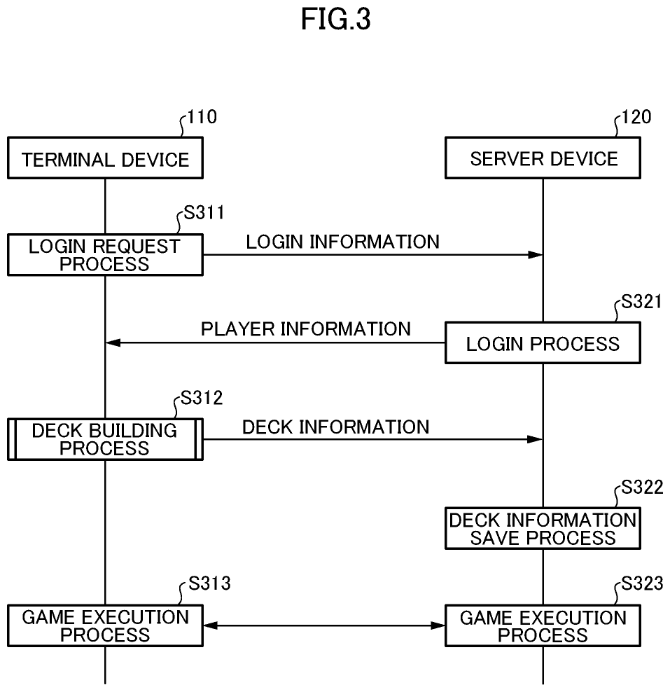

On the basis of the aforementioned functional structure, the terminal device 110 of this embodiment performs various processes in cooperation with the server device 120 according to the flow illustrated in FIG. 3 when a battle game is provided to the user.

FIG. 3 is an exemplary and schematic sequence diagram illustrating the flow of processes performed by the terminal device 110 and the server device 120 according to this embodiment.

As illustrated in FIG. 3, in this embodiment, first, in S311, the terminal device 110 (for example, the game control processing unit 203) performs a login request process for acquiring the player information of the user of the terminal device 110 from the server device 120 and transmits login information including the identification information of that user to the server device 120. This process in S311 is performed when the application installed in the terminal device 110 to provide the battle game is started.

In S321, the server device 120 performs a login process on the basis of the login information received from the terminal device 110, extracts the corresponding player information from among the player information recorded therein, and transmits the extracted player information to the terminal device 110.

Then, in S312, the terminal device 110 (for example, the accepting processing unit 201, the administration processing unit 202, and the display processing unit 204) performs a deck-building process of building a deck used in the battle game according to the operation by the user, and transmits the deck information regarding the built deck to the server device 120. Although the details are described later, the deck-building process involves accepting the operation by the user through the accepting processing unit 201 and administering the deck through the administration processing unit 202 while displaying various images (screens) on the display 110A by the display processing unit 204 as necessary.

In S322, the server device 120 performs a deck information save process of saving the deck information received from the terminal device 110 and updating the player information recorded therein.

Next, in S313 and S323, respectively, the terminal device 110 (for example, the accepting processing unit 201, the game control processing unit 203, and the display processing unit 204) and the server device 120 perform a game execution process of executing a battle game in cooperation with each other via communication. The game execution process is a process that involves accepting the operation by the user through the accepting processing unit 201 and controlling the progress of the game through the game control processing unit 203 while displaying various images (screens) on the display 110A through the display processing unit 204.

In this embodiment, the deck-building process in S312 described above includes, as described below, a process of letting the user select the class of cards to be included in the deck used in the battle game, a process of letting the user select cards to be included in the deck, a process of saving the built deck, a process of displaying various images used in these processes on the display 110A, etc.

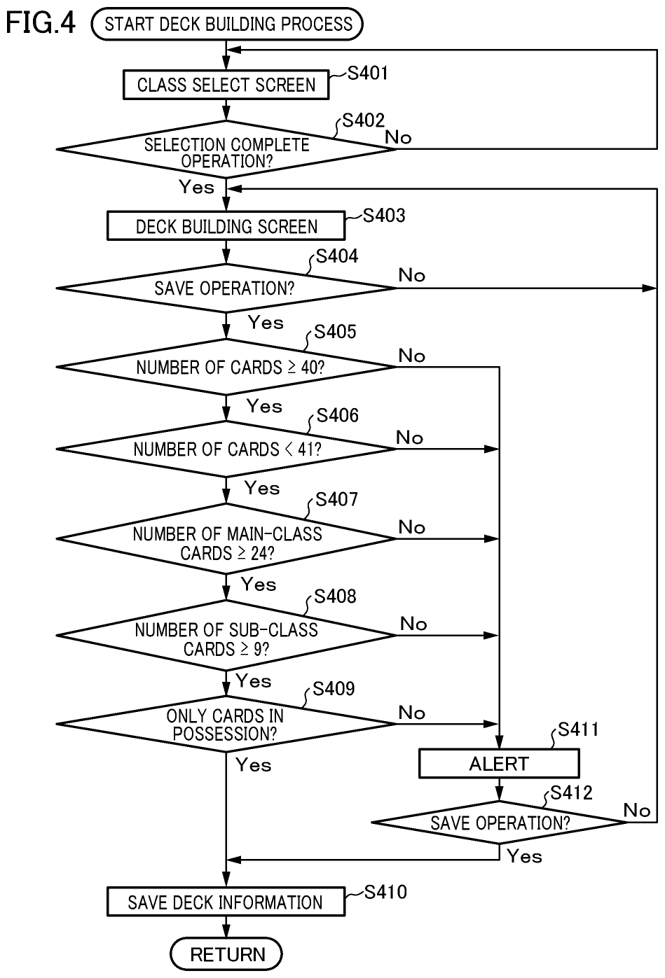

FIG. 4 is an exemplary and schematic flowchart illustrating the flow of the deck-building process performed by the terminal device 110 according to an embodiment.

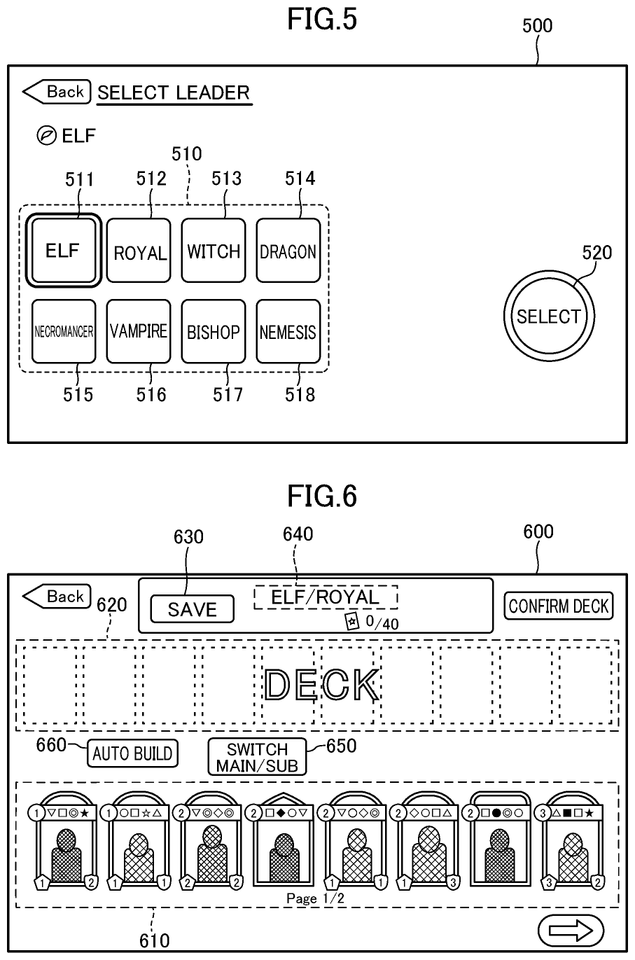

As illustrated in FIG. 4, in the deck-building process, first, in S401, the display processing unit 204 displays, on the display 110A, a class select screen, such as the one illustrated in FIG. 5 below, used to let the user select the class of the cards to be included in the deck used in the battle game. Next, the accepting processing unit 201 accepts input of the operation by the user through the class select screen.

FIG. 5 is an exemplary and schematic diagram illustrating one example of the class select screen according to an embodiment.

An image 500 illustrated in FIG. 5 is one example of the class select screen. This image 500 includes a region 510 that accepts selection of the class to be included in the deck used in the battle game, and a select button 520 for finalizing the selection.

Under the condition where a deck including cards of multiple classes is to be used in a battle game, the user can select multiple classes of the cards to be included in the deck by performing operations on the region 510, for example, a touch operation of the display 110A through a touch panel. Selection of these multiple classes is finalized when a selection complete operation, which is an operation of touching the select button 520, is performed.

In the description below, for the sake of simplicity, only the case in which two classes are to be selected through the class select screen is described; however, the features of the present disclosure can also be applied in a similar manner to the case in which three or more classes are to be selected through the class select screen.

For example, in the example illustrated in FIG. 5, a select button 511 that accepts the selection of the class “Elf”, a select button 512 that accepts the selection of the class “Royal”, a select button 513 that accepts the selection of the class “Witch”, and a select button 514 that accepts the selection of the class “Dragon” are displayed in the region 510. In addition, a select button 515 that accepts the selection of the class “Necromancer”, a select button 516 that accepts the selection of the class “Vampire”, a select button 517 that accepts the selection of the class “Bishop”, and a select button 518 that accepts the selection of the class “Nemesis” are also displayed in the region 510.

Under the condition where a deck including cards of two classes is to be used in a battle game, the user can select two classes of cards to be included in the deck by operating any desired two of the eight select buttons 511 to 518 described above. Selection of these two classes is finalized when a selection complete operation using the select button 520 is performed. Here, the class selected first is, for example, the main class, which is the main attribute that becomes the leading force of the deck, and the class selected second is, for example, the sub class, which is the sub attribute that assists the leading force. In this embodiment, a limitation is imposed that the minimum number predetermined for the main class must be larger than the minimum number predetermined for the sub class.

Referring back to FIG. 4, in S402, the accepting processing unit 201 judges whether or not the selection complete operation, for example, a touch operation on the select button 520, is performed. In S402, if it is judged that the select complete operation has not been performed, the process returns to S401, and the accepting processing unit 201 continues to accept the input of the operation by the user through the class select screen.

Meanwhile, in S402, if it is judged that the selection complete operation has been performed, the process proceeds to S403. Then, in S403, the display processing unit 204 displays, on the display 110A, a deck building screen such as the one illustrated in FIG. 6 below to let the user select the cards to be included in the deck. Next, the accepting processing unit 201 accepts input of the operation by the user through the deck building screen.

FIG. 6 is an exemplary and schematic diagram illustrating one example of a deck building screen according to an embodiment.

An image 600 illustrated in FIG. 6 is one example of the deck building screen. This image 600 includes a first region 610, a second region 620, a save button 630, a third region 640, a class switch button 650, and an auto build button 660.

The first region 610 displays, for example, a list of the cards associated with the classes selected through the aforementioned class select screen and the cards that have so-called “neutral” characteristics and are treated as no-class (or corresponding to all classes) as the data from among the cards that the user digitally owns. In the second region 620, a list of the cards in the deck is displayed. The user performs an operation of selecting a card displayed in the first region 610 (for example, a touch operation) and an operation of moving the selected card to the second region 620 (for example, a swipe operation) to build a deck. The built deck is saved through a specified judgment process described below for judging whether or not the number of cards in the deck satisfies the predetermined condition, when the operation of the save button 630 (for example, a touch operation) is performed.

It should be noted here that the aforementioned display mode of displaying the list of the main class cards, the sub class cards, and the “neutral” cards in the first region 610 is merely one example. In one embodiment, all of the cards owned by the user can be displayed in the first region 610 by default. In such a case, the user can use a card filter function that can be called from the deck building screen so as to extract (search for) only the desired cards from among all cards, and can have only the desired cards displayed in the first region 610.

In the third region 640, the name of the deck that is currently being built is displayed. The user can freely change the name of the deck. By default, the deck is given a name constituted by the name of the main class and the name of the sub class arranged in this order from the left and separated by a slash sign (in the example illustrated in FIG. 6, “Elf/Royal”). As long as the order of the arrangement of the main class and the sub class in the default deck name is fixed, it becomes easy to identify, from the default deck name, which is the main class with a relatively larger number of cards and which is the sub class with a relatively smaller number of cards.

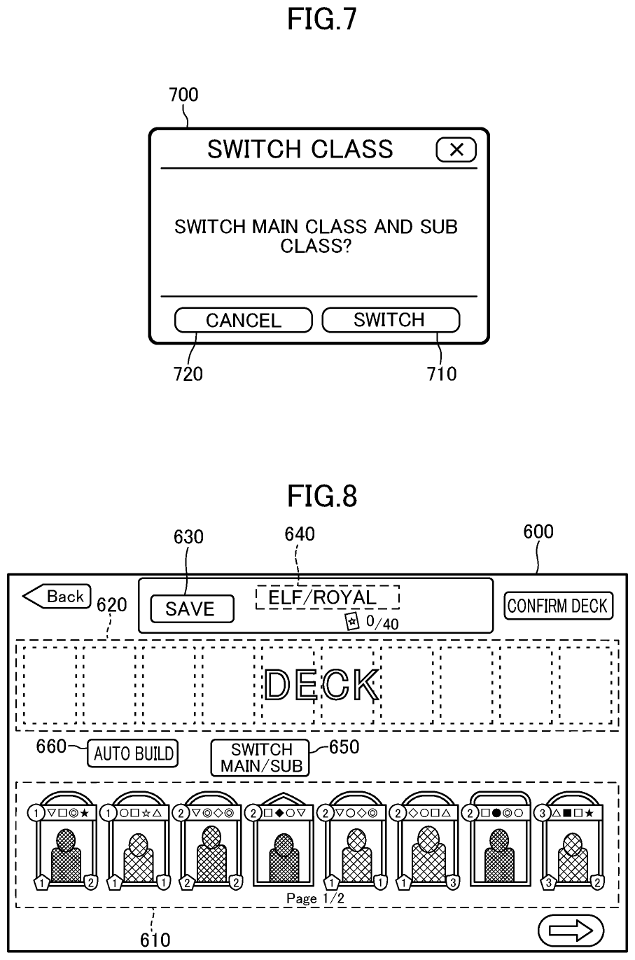

A class switch button 650 accepts the operation of switching between the main class and the sub class on the deck building screen in order to save the trouble of going back to the class select screen for the operation of switching between the main class and the sub class. When an operation on the class switch button 650 (for example, a touch operation) is performed, a switch confirmation image such as the one illustrated in FIG. 7 described below pops up on the deck building screen.

FIG. 7 is an exemplary and schematic diagram illustrating one example of a switch confirmation image that is displayed when switch is made between the main class and the sub class in this embodiment.

An image 700 illustrated in FIG. 7 is one example of the switch confirmation image. This image 700 displays a message that prompts the user to confirm if it is alright to switch from/to the main class to/from the sub class.

Furthermore, the image 700 includes an execute button 710 and a cancel button 720. When an operation on the cancel button 720 (for example, a touch operation) is performed, the deck building screen such as the one illustrated in FIG. 6 is displayed again. In contrast, when an operation on the execute button 710 (for example, a touch operation) is performed, a deck building screen such as the one illustrated in FIG. 8 below is displayed, in which the main class and the sub class are switched from the example illustrated in FIG. 6.

FIG. 8 is an exemplary and schematic diagram illustrating a deck building screen according to an embodiment in which the main class and the sub class are switched from the example illustrated in FIG. 6.

An image 800 illustrated in FIG. 8 is a deck building screen in which the main class and the sub class are switched from the example illustrated in FIG. 6. This image 800 has the same screen structure as the image 600 illustrated in FIG. 6. However, in this image 800, since the main class and the sub class are switched, the deck name (“Royal/Elf”) displayed in the third region 640 has the main class and the sub class arranged in the reverse order with respect to the deck name (“Elf/Royal”) displayed in the third region 640 in the image 600 illustrated in FIG. 6.

Referring back to FIG. 4, in S404, the accepting processing unit 201 judges whether or not a deck save operation, for example, a touch operation on the save button 630, is performed through the deck building screen. In S404, if it is judged that the save operation has not been performed, the process returns to S403, and the accepting processing unit 201 continues to accept the input of the operation by the user through the deck building screen.

Meanwhile, in S404, if it is judged that the save operation has been performed, the process proceeds to S405. Then, in S405 and onward, a specified judgment process for judging whether or not the number of cards in the deck satisfies a predetermined condition is performed.

More specifically, in S405, the administration processing unit 202 judges whether or not the number of all cards included in the deck is 40 or more. Note that the number “40” corresponds to the aforementioned specified number predetermined as the necessary and sufficient number of cards constituting the deck. Naturally, the number “40” is one example, and any number other than 40 may be used as the specified number in an embodiment. Furthermore, in an embodiment, the specified number may be set as any desired range having an upper limit and a lower limit, for example, 39 to 41.

In S405, if it is judged that the number of all cards included in the deck is 40 or more, the process proceeds to S406. In S406, the administration processing unit 202 judges whether or not the number of all cards included in the deck is less than 41, in other words, whether or not the deck includes exactly the specified number of cards.

In S406, if it is judged that the number of all cards included in the deck is less than 41, the condition concerning the number of all cards included in the deck is satisfied. In such a case, a process of judging whether or not the condition related to the aforementioned minimum number predetermined for each class is satisfied is performed through the process in S407 and onward.

More specifically, in S407, the administration processing unit 202 judges whether or not the number of main-class cards included in the deck is 24 or more. Note that the number “24” corresponds to the aforementioned minimum number predetermined as the minimum number of main-class cards required to be included in the deck. Naturally, the number “24” is one example, and any number other than 24 may be used as the minimum number of the main-class cards in an embodiment.

In S407, if it is judged that the number of main-class cards is 24 or more, the process proceeds to S408. In S408, the administration processing unit 202 judges whether or not the number of sub-class cards included in the deck is 9 or more. Note that the number “9” corresponds to the aforementioned minimum number predetermined as the minimum number of sub-class cards required to be included in the deck. Naturally, the number “9” is one example, and any number other than 9 and smaller than the minimum number of the main-class cards may be used as the minimum number of the sub-class cards in an embodiment.

Here, in the example described above, the minimum number of main-class cards is 24, the minimum number of the sub-class cards is 9, and the sum of the two (24+9), 33, is smaller than the specified number 40. Thus, in this embodiment, it is possible to include, in the deck, up to seven cards that have a “neutral” property corresponding to neither the main class nor the sub class. In this way, the gameplay is further improved.

In an embodiment, in building a deck, it is possible to use a deck built by another person publicly available on the Internet or the like. However, a deck built by another person may include cards that the user does not own, and a deck including the cards that the user does not own cannot be used in a battle game. Thus, it is desirable to check whether the deck is built by using only the cards owned by the user.

In S408, if it is judged that the number of sub-class cards is 9 or more, the process proceeds to S409. In S409, the administration processing unit 202 judges whether the deck about to be saved is built solely by using the cards owned by the user.

In S409, if it is judged that the deck is built solely by using the cards owned by the user, it can be judged that a deck that can be used in a battle game has been built. In such a case, the process proceeds to S410. In S410, the administration processing unit 202 saves the deck information concerning the built deck and shares the saved deck information with the server device 120.

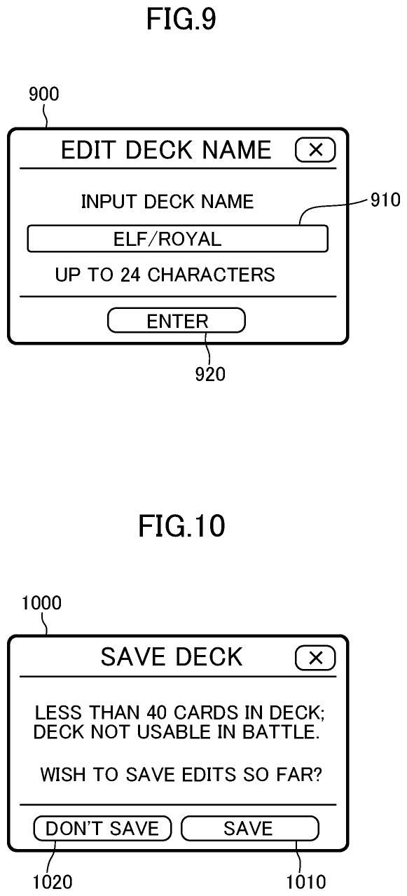

Note that when the deck information is saved in S410, it is preferable, prior to the saving, to prompt the user to confirm whether it is alright to finalize saving of the deck information. Thus, in an embodiment, the display processing unit 204 displays a save confirmation image such as the one illustrated in FIG. 9 below before saving the deck information. Then the accepting processing unit 201 accepts input of the operation by the user through the save confirmation image.

FIG. 9 is an exemplary and schematic diagram illustrating one example of the save confirmation image according to an embodiment.

An image 900 illustrated in FIG. 9 is one example of the save confirmation image. This image 900 displays a message prompting the input of the name of the deck.

Furthermore, the image 900 includes a region 910 where the input deck name is displayed, and an enter button 920. In this manner, the user can finalize saving of the deck information by performing an operation (for example, a touch operation) on the enter button 920 after inputting the name of the deck while confirming the region 910.

Here, referring back to FIG. 4, if the conditions are not satisfied in S405 to S409 described above, it is preferable to inform the user accordingly.

In this embodiment, if the conditions in S405 to S409 are not satisfied, the process proceeds to S411. In S411, the display processing unit 204 displays a save alert image such as the ones illustrated in FIGS. 10 to 14 below to inform the user of the fact that a deck not satisfying the conditions is about to be saved. Then the accepting processing unit 201 accepts input of the operation by the user through the save alert image.

FIG. 10 is an exemplary and schematic diagram illustrating one example of a save alert image according to an embodiment.

An image 1000 illustrated in FIG. 10 is one example of the save alert image displayed when the condition in S405 described above is not satisfied. This image 1000 displays a message informing the user that the deck not satisfying the condition in S405 described above is about to be saved and a message confirming the user whether or not to save the deck with the understanding that the condition is not satisfied.

Furthermore, the image 1000 includes a save button 1010 and a cancel button 1020. In this manner, the user knowing that the condition in S405 is not satisfied can finalize saving of the deck by performing the operation (for example, a touch operation) on the save button 1010. When the operation on the cancel button 1020 (for example, a touch operation) is performed, the deck building screen such as the one illustrated in FIG. 6 is displayed again.

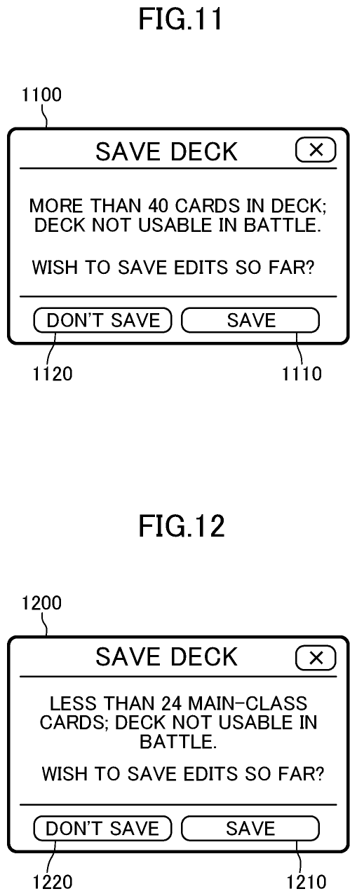

FIG. 11 is an exemplary and schematic diagram illustrating one example of a save alert image according to an embodiment different from the one illustrated in FIG. 10.

An image 1100 illustrated in FIG. 11 is one example of the save alert image displayed when the condition in S406 described above is not satisfied. This image 1100 displays a message informing the user that the deck not satisfying the condition in S406 described above is about to be saved and a message confirming the user whether or not to save the deck with the understanding that the condition is not satisfied.

Furthermore, the image 1100 includes a save button 1110 and a cancel button 1120. In this manner, the user knowing that the condition in S406 is not satisfied can finalize saving of the deck by performing the operation (for example, a touch operation) on the save button 1110. When the operation on the cancel button 1120 (for example, a touch operation) is performed, the deck building screen such as the one illustrated in FIG. 6 is displayed again.

FIG. 12 is an exemplary and schematic diagram illustrating one example of a save alert image according to an embodiment different from the ones illustrated in FIGS. 10 and 11.

An image 1200 illustrated in FIG. 12 is one example of the save alert image displayed when the condition in S407 described above is not satisfied. This image 1200 displays a message informing the user that the deck not satisfying the condition in S407 described above is about to be saved and a message confirming the user whether or not to save the deck with the understanding that the condition is not satisfied.

Furthermore, the image 1200 includes a save button 1210 and a cancel button 1220. In this manner, the user knowing that the condition in S407 is not satisfied can finalize saving of the deck by performing the operation (for example, a touch operation) on the save button 1210. When the operation on the cancel button 1220 (for example, a touch operation) is performed, the deck building screen such as the one illustrated in FIG. 6 is displayed again.

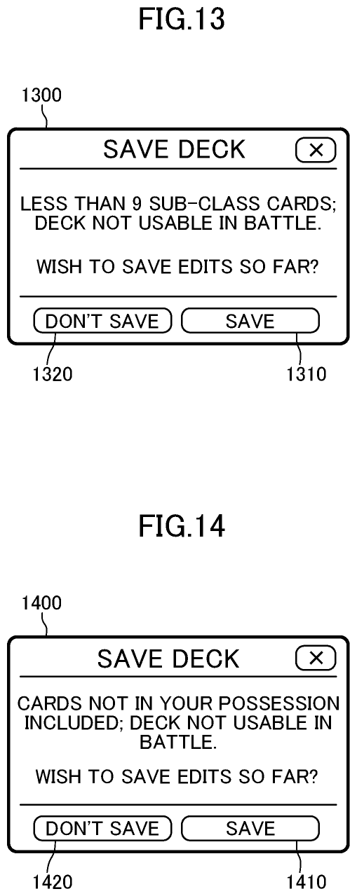

FIG. 13 is an exemplary and schematic diagram illustrating one example of a save alert image according to an embodiment different from the ones illustrated in FIGS. 10 to 12.

An image 1300 illustrated in FIG. 13 is one example of the save alert image displayed when the condition in S408 described above is not satisfied. This image 1300 displays a message informing the user that the deck not satisfying the condition in S408 described above is about to be saved and a message confirming the user whether or not to save the deck with the understanding that the condition is not satisfied.

Furthermore, the image 1300 includes a save button 1310 and a cancel button 1320. In this manner, the user knowing that the condition in S408 is not satisfied can finalize saving of the deck by performing the operation (for example, a touch operation) on the save button 1310. When the operation on the cancel button 1320 (for example, a touch operation) is performed, the deck building screen such as the one illustrated in FIG. 6 is displayed again.

FIG. 14 is an exemplary and schematic diagram illustrating one example of a save alert image according to an embodiment different from the ones illustrated in FIGS. 10 to 13.

An image 1400 illustrated in FIG. 14 is one example of the save alert image displayed when the condition in S409 described above is not satisfied. This image 1400 displays a message informing the user that the deck not satisfying the condition in S409 described above is about to be saved and a message confirming the user whether or not to save the deck with the understanding that the condition is not satisfied.

Furthermore, the image 1400 includes a save button 1410 and a cancel button 1420. In this manner, the user knowing that the condition in S409 is not satisfied can finalize saving of the deck by performing the operation (for example, a touch operation) on the save button 1410. When the operation on the cancel button 1420 (for example, a touch operation) is performed, the deck building screen such as the one illustrated in FIG. 6 is displayed again.

Referring back to FIG. 4, when the process in S411 is performed, the process proceeds to S412. In S412, the accepting processing unit 201 judges whether or not a save operation, for example, an operation (for example, a touch operation) on the aforementioned save button 1010, 1110, 1210, 1310, or 1410, has been performed.

In S411, if it is judged that the save operation has not been performed, that is, if it is judged that the cancel button 1020, 1120, 1220, 1320, or 1420 has been operated (for example, touched), the process returns to S403 described above. Meanwhile, in S411, if it is judged that the save operation has been performed, the process proceeds to S410 described above.

When the process in S410 is completed, a series of processes illustrated in FIG. 4, that is, the process in S312 illustrated in FIG. 3, ends.

Note that the conditions in S405 to S409 described above can also be considered in automatically building a deck according to the operation (for example, a touch operation) on the auto build button 660 in the deck building screen illustrated in FIG. 6 or 8. In other words, in an embodiment, when the auto build button 660 is operated, a specified number of cards are automatically selected from among the cards owned by the user such that all of the conditions in S405 to S409 described above are satisfied, and thus a deck is built. In selecting the cards, the cost predetermined for each card as play points required to play that card in a battle game, the priority freely set for each card by the administrator of the battle game on the basis of the rate in which all cards are used, and other factors can be taken into account.

Note that when a card having an expiration date is included in the deck and when a long time has passed between when the deck is built and when the deck is used to play an actual battle game, it is possible that the deck cannot be used in playing this actual battle game due to expiration.

Thus, in this embodiment, the judgement of the conditions in S405 to S409 described above can also be performed on the server device 120 side at the time of starting the battle game, that is, before S313 and S323 illustrated in FIG. 3. Here, if the deck cannot be used, the server device 120 notifies the terminal device 110 accordingly. In this manner, it becomes possible to avoid playing a battle game with an unusable deck.

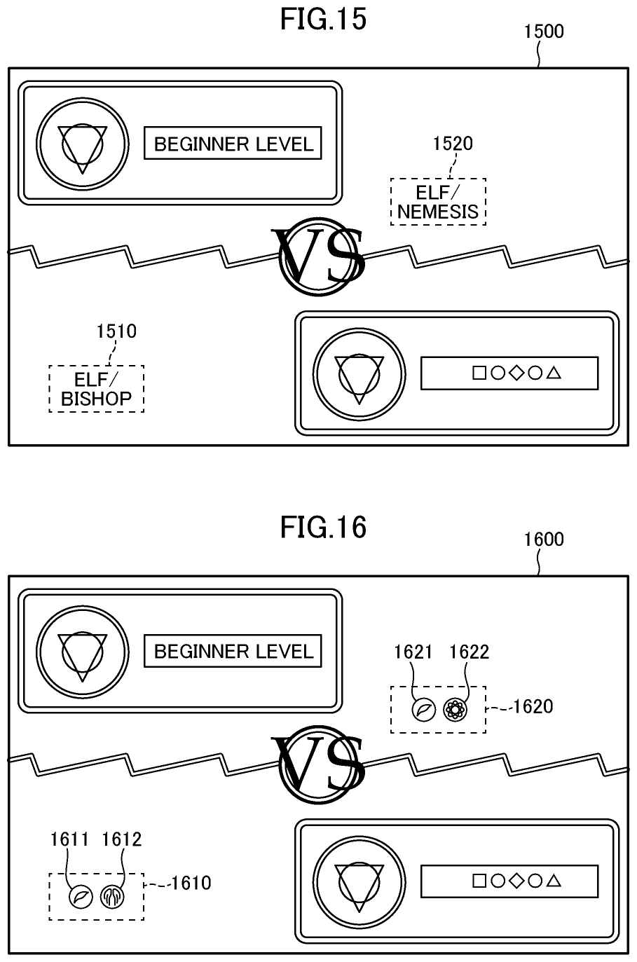

In an embodiment, it is desirable that the user be able to confirm the classes of the cards included in the deck not only in building the deck but also at the start (which can include before the start) and after the start of the battle game. Here, it is desirable that the user be able to confirm not only the classes of the cards included in the user's deck but also the classes of the cards included in the opponent's deck. Thus, in an embodiment, the display processing unit 204 can display the classes of the cards included in the decks through the images (screens) such as the ones illustrated in FIGS. 15 to 21 below.

For example, in an embodiment, the display processing unit 204 can display a battle start screen such as the one illustrated in FIG. 15 below at the start of the battle game, and can display the classes of the cards included in the user's deck and the classes of the cards included in the opponent's deck on that battle start screen.

First, FIG. 15 is an exemplary and schematic diagram illustrating one example of a battle start screen according to an embodiment.

An image 1500 illustrated in FIG. 15 is one example of the battle start screen. The image 1500 includes a first region 1510 where the classes of the cards included in the user's deck are displayed, and a second region 1520 where the classes of the cards included in the opponent's deck are displayed.

In the example illustrated in FIG. 15, the classes of the cards included in the deck are indicated such that the text indicating the main class and the text indicating the sub class are arranged in this order from the left and separated by a slash sign (“Elf/Bishop” and “Elf/Nemesis”). However, in an embodiment, the classes of the cards included in the deck do not have to be indicated through text, such as in the example illustrated in FIG. 16 below.

FIG. 16 is an exemplary and schematic diagram illustrating one example of a battle start screen according to an embodiment different from the one illustrated in FIG. 15.

An image 1600 illustrated in FIG. 16 is one example of the battle start screen in which the classes of the cards included in the decks are indicated as information other than text. The image 1600 includes a first region 1610 where the classes of the cards included in the user's deck are displayed, and a second region 1620 where the classes of the cards included in the opponent's deck are displayed.

In the first region 1610, an image 1611 indicating “Elf”, which is the main class of the cards included in the user's deck, and an image 1612 indicating “Bishop”, which is the sub class of the cards included in the user's deck, are arranged in this order from the left. In the second region 1620, an image 1621 indicating “Elf”, which is the main class of the cards included in the opponent's deck, and an image 1622 indicating “Nemesis”, which is the sub class of the cards included in the opponent's deck, are arranged in this order from the left.

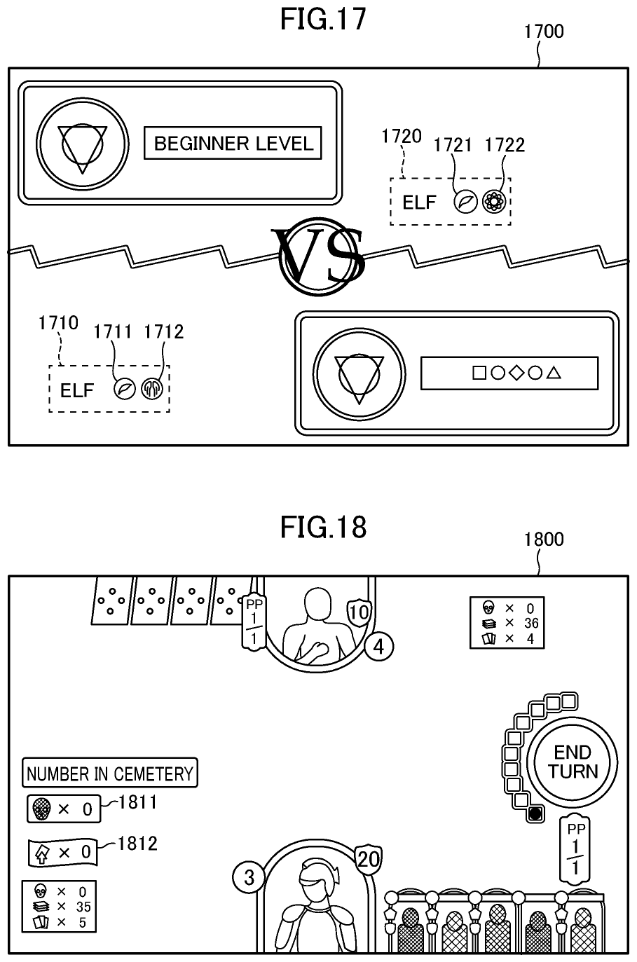

In the example illustrated in FIG. 16, the classes of the cards included in the deck are graphically indicated. However, in an embodiment, the classes of the cards included in the deck may be indicated by a combination of text and images, as in the example illustrated in FIG. 17 below.

FIG. 17 is an exemplary and schematic diagram illustrating one example of a battle start screen according to an embodiment different from the ones illustrated in FIGS. 15 and 16.

An image 1700 illustrated in FIG. 17 is one example of the battle start screen in which the classes of the cards included in the deck are indicated as information that uses a combination of text and graphics. The image 1700 includes a first region 1710 where the classes of the cards included in the user's deck are displayed, and a second region 1720 where the classes of the cards included in the opponent's deck are displayed.

In the first region 1710, the text “Elf” as the main class of the cards included in the user's deck, an image 1711 indicating “Elf” as the main class of the cards included in the user's deck, and an image 1712 indicating “Bishop” as the sub class of the cards included in the user's deck are arranged in this order from the left. In the second region 1720, the text “Elf” as the main class of the cards included in the opponent's deck, an image 1721 indicating “Elf” as the main class of the cards included in the opponent's deck, and an image 1722 indicating “Nemesis” as the sub class of the cards included in the opponent's deck are arranged in this order from the left.

In the example illustrated in FIG. 17, only the main class is indicated by text, and the sub class is not indicated by text; alternatively, in an embodiment, both the main class and the sub class may be indicated by text.

Furthermore, in an embodiment, the display processing unit 204 can display, after the start of the battle game, a battle screen such as the one illustrated in FIG. 18 below and can display, on this battle screen, supplemental information associated with the classes of the cards included in the deck so that the user can confirm the classes of the cards included in the deck. The supplemental information is information that indicates the abilities, etc., that are predetermined for each class.

FIG. 18 is an exemplary and schematic diagram illustrating one example of a battle screen according to an embodiment.

An image 1800 illustrated in FIG. 18 is one example of the battle screen. The image 1600 includes first information 1811 serving as supplemental information associated with “Necromancer” as the main class of the cards included in the user's deck, and second information 1812 serving as supplemental information associated with “Elf” as the sub class of the cards included in the user's deck. In this manner, the user can easily confirm the main class and the sub class of the cards included in the user's deck, and the abilities of the main class and the sub class while playing the battle game.

In the example illustrated in FIG. 18, supplemental information about the classes (main class and sub class) of the cards included in the opponent's deck are not displayed on the battle screen. Alternatively, in an embodiment, the supplemental information of the classes of the cards included in the opponent's deck can also be displayed on the battle screen. In this case, the user can (indirectly) grasp the classes included in the opponent's deck by confirming the supplemental information of the opponent.

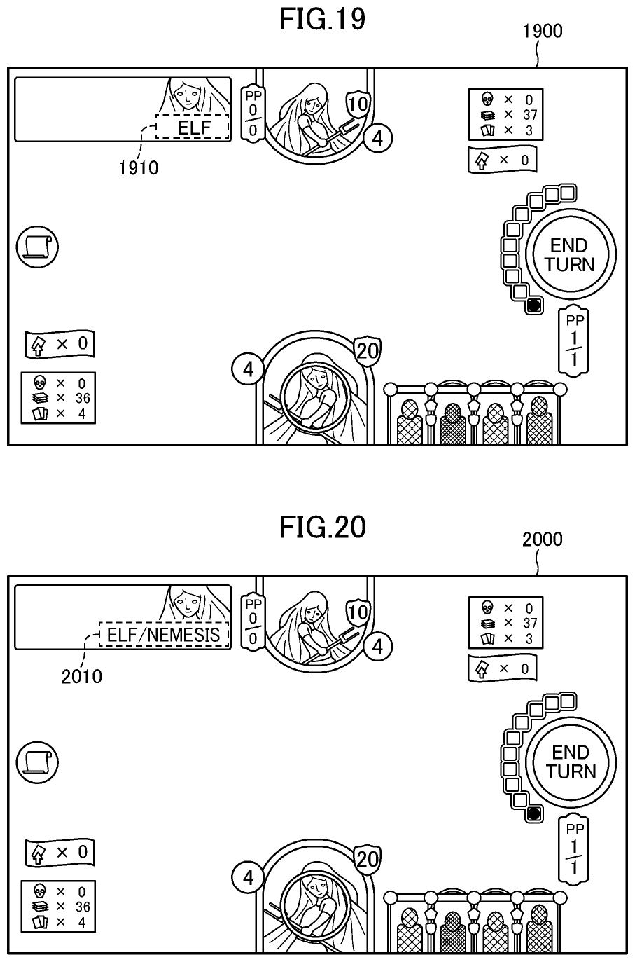

Alternatively, in an embodiment, the classes of the cards included in the opponent's deck can also be displayed on the battle screen in a manner illustrated in FIG. 19 below, for example.

FIG. 19 is an exemplary and schematic diagram illustrating one example of a battle screen according to an embodiment different from the one illustrated in FIG. 18.

An image 1900 illustrated in FIG. 19 is one example of the battle screen in which only the main class is indicated from among the classes of the cards included in the opponent's deck. This image 1900 includes a region 1910 where the text “Elf” as the main class of the cards included in the opponent's deck is displayed. In this manner, the user can easily confirm the main class of the cards included in the opponent's deck while playing the battle game.

In the example illustrated in FIG. 19, the sub class of the cards included in the opponent's deck is not displayed on the battle screen. Alternatively, in an embodiment, as illustrated in FIG. 20 below, both the main class and the sub class of the cards included in the opponent's deck can be displayed on the battle screen.

FIG. 20 is an exemplary and schematic diagram illustrating one example of a battle screen according to an embodiment different from the ones illustrated in FIGS. 18 and 19.

An image 2000 illustrated in FIG. 20 is one example of a battle screen in which both the main class and the sub class of the cards included in the opponent's deck are displayed. This image 2000 includes a region 2010 where the text “Elf” as the main class of the cards included in the opponent's deck and the text “Nemesis” as the sub class of the cards included in the opponent's deck are arranged in this order from the left and separated by a slash sign. In this manner, the user can easily confirm both the main class and the sub class of the cards included in the opponent's deck while playing the battle game.

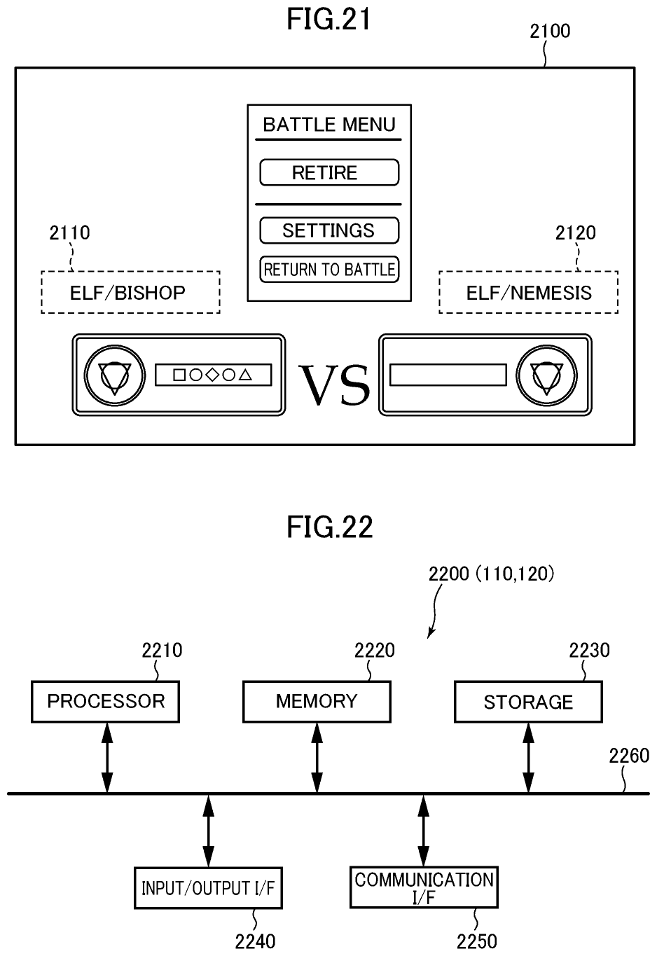

Alternatively, in an embodiment, as illustrated in FIG. 21 below, it is possible to display the classes of the cards included in the decks in a pause screen displayed during pausing after the start of the battle game. The pause screen can be displayed in response to the operation (for example, a touch operation) on a pause button (not illustrated) provided on the battle screen.

FIG. 21 is an exemplary and schematic diagram illustrating one example of a pause screen according to an embodiment.

An image 2100 illustrated in FIG. 21 is one example of the pause screen. This image 2100 includes a first region 2110 and a second region 2120. In the first region 2110, the text “Elf” as the main class of the cards included in the user's deck and the text “Bishop” as the sub class of the cards included in the user's deck are arranged in this order from the left and separated by a slash sign. In the second region 2120, the text “Elf” as the main class of the cards included in the opponent's deck and the text “Nemesis” as the sub class of the cards included in the opponent's deck are arranged in this order from the left and separated by a slash sign. In this manner, the user can easily confirm all of the main class and the sub class of the cards included in the user's deck and the main class and the sub class of the cards included in the opponent's deck while the battle game is being paused.

As described heretofore, the terminal device 110 according to this embodiment is configured to provide, to the user, a battle game that uses a deck that includes a specified number of cards selected from among cards each associated with a class. The terminal device 110 includes an accepting processing unit 201, an administration processing unit 202, and a display processing unit 204. The accepting processing unit 201 is configured to accept, before starting the battle game, the user's selection of multiple classes of the cards to be included in the deck used in the battle game. The administration processing unit 202 administers the deck such that, for each of the multiple classes selected by the user, the number of cards of the class becomes equal to or more than the minimum number predetermined for each class. The display processing unit 204 is configured to display multiple classes selected by the user and multiple classes of the specified number of cards included in the deck used by the opponent that the user plays against.

According to the aforementioned features, the user plays a battle game while taking into account multiple classes selected by the user and multiple classes of the specified number of cards included in the deck used by the opponent that the user plays against. Thus, unlike the case where a limitation is imposed that requires a deck be built by using cards of a single class, a battle game with improved strategies concerning the class can be provided.

For example, in an embodiment, multiple classes include a main class and a sub class, and the minimum number for the main class is larger than the minimum number for the sub class. According to such a feature, the user must strategically build a deck by taking into consideration the minimum numbers for the main class and the sub class, and thus the strategies of the battle game can be further improved.

Furthermore, in an embodiment, the display processing unit 204 can display, on the battle start screen displayed at the start of the battle game, text or images that indicate multiple classes selected by the user and multiple classes of the specified number of cards included in the deck used by the opponent (for example, see FIGS. 15 to 17). According to this feature, what decks are used in playing the battle game can be easily confirmed at the start of the battle game.

Furthermore, in an embodiment, the display processing unit 204 can display, on the battle screen displayed after the start of the battle game, multiple pieces of supplemental information respectively associated with multiple classes selected by the user (for example, see FIG. 18). In this manner, the user can easily confirm the supplemental information regarding the user's own deck while playing the battle game.

Furthermore, in an embodiment, the display processing unit 204 can display, on the battle screen displayed after the start of the battle game, the text or images that indicate all of multiple classes of the specified number of cards included in the deck used by the opponent or one class of the most cards among the specified number of cards included in the deck used by the opponent (for example, see FIGS. 19 and 20). In this manner, the user can easily confirm at least one of the classes used by the opponent while playing the battle game.

Furthermore, in an embodiment, the display processing unit 204 can display, on the pause screen displayed during pausing after the start of the battle game, text or images that indicate multiple classes selected by the user and multiple classes of the specified number of cards included in the deck used by the opponent (for example, see FIG. 21). In this manner, what decks are used to play the battle game can be easily confirmed during the pause of the battle game.

In an embodiment, the display processing unit 204 can display multiple classes selected by the user in such a manner that the magnitude of the number of cards in each of the classes is identifiable, and can display multiple classes of the specified number of cards included in the deck used by the opponent in such a manner that the magnitude of the number of cards in each of the classes is identifiable. In this manner, the user can play a battle game while confirming the number of cards in each class included in the user's own deck and roughly estimating the number of cards in each class included in the opponent's deck. Thus, the strategy of the battle game can be further improved.

Lastly, the hardware configuration of the terminal device 110 and the server device 120 relevant to the embodiments described above is described. Authentication modules according to an embodiment are configured as, for example, an information processing apparatus 2200 having a hardware configuration equivalent to typical computers such as the one illustrated in FIG. 22 below.

FIG. 22 is an exemplary and schematic block diagram illustrating one example of the hardware configuration of the information processing apparatus 2200 constituting the terminal device 110 and the server device 120 according to an embodiment.

As illustrated in FIG. 22, the information processing apparatus 2200 includes a processor 2210, a memory 2220, a storage 2230, an input/output interface (I/F) 2240, and a communication interface (I/F) 2250. These hardware devices are connected to a bus 2260.

The processor 2210 is, for example, configured as a central processing unit (CPU) and integrally controls the operations of the individual units of the information processing apparatus 2200.

The memory 2220 includes, for example, a read-only memory (ROM) and a random access memory (RAM) and makes it possible to provide volatile and non-volatile memories for various pieces of data such as programs to be run by the processor 2210, and to provide work areas used by the processor 2210 to run the programs.

The storage 2230 includes, for example, a hard disk drive (HDD) or a solid-state drive (SSD) and stores various pieces of data in a non-volatile manner.

The input/output interface 2240 controls input of data from input devices, such as a touch panel, a keyboard, and a mouse, to the information processing apparatus 2200 and output of data from the information processing apparatus 2200 to output devices, such as a display and a speaker, for example.

The communication interface 2250 enables the information processing apparatus 2200 to communicate with other devices.

The functional structure (see FIG. 2) of the terminal device 110 according to an embodiment is achieved as a functional module group in which hardware and software work in cooperation as a result of the processor 2210 executing the programs preliminarily stored in the memory 2220 or the storage 2230. However, in an embodiment, part or the entirety of the functional module group illustrated in FIG. 2 may be configured only by hardware, such as specially designed circuitry. Furthermore, in an embodiment, at least part of the functional module group illustrated in FIG. 2 may be implemented in the server device 120.

The aforementioned programs do not have to be preliminarily stored in the memory 2220 or the storage 2230. For example, the programs described above may be provided as computer program products that have been recorded in computer-readable media, such as various magnetic disks including flexible disks (FDs) and various optical disks such as digital versatile disks (DVDs), in a manner that can be installed or executed.

Alternatively, the programs may be provided or distributed through a network such as the Internet. In other words, the aforementioned programs may be stored on a computers connected to a network such as the Internet and may be provided by accepting a download via the network.

Although several embodiments of the present disclosure and modifications thereof have been described above, these embodiments and modifications are merely exemplary and are not intended to limit the scope of the invention. These novel embodiments and modifications thereof can be implemented in various other forms, and various omissions, substitutions, and alterations are possible without departing from the gist of the invention. These embodiments and modifications thereof are within the scope or gist of the invention as well as within the scope the invention recited in the claims and equivalents thereof.

### REFERENCE SIGNS LIST

110 terminal device
201 accepting processing unit
202 administration processing unit
204 display processing unit

1. A non-transitory computer readable medium storing a program for instructing a computer to provide, to a user, a battle game that uses a deck including a specified number of game media selected from among a plurality of game media each associated with an attribute, the program instructing the computer to perform:
before the start of the battle game, accepting selection of a plurality of attributes of the game media to be included in the deck used in the battle game, the selection being made by the user,
administering the deck such that, for each of the plurality of attributes selected by the user, the number of game media associated with that attribute becomes equal to or larger than a minimum number predetermined for each attribute, and
displaying the plurality of attributes selected by the user and the plurality of attributes of the predetermined number of game media included in the deck used by an opponent that the user plays against.

2. The non-transitory computer readable medium according to claim 1,
wherein the plurality of attributes include a main attribute and a sub attribute, and
the minimum number for the main attribute is larger than the minimum number for the sub attribute.

3. The non-transitory computer readable medium according to claim 1,
wherein the displaying includes displaying, on a battle start screen displayed at the start of the battle game, text or images that indicate the plurality of attributes selected by the user and the plurality of attributes of the predetermined number of game media included in the deck used by the opponent.

4. The non-transitory computer readable medium according to claim 1,
wherein the displaying includes displaying, on a battle screen displayed after the start of the battle game, a plurality of pieces of supplemental information respectively associated with the plurality of attributes selected by the user.

5. The non-transitory computer readable medium according to claim 1,
wherein the displaying includes displaying, on a battle screen displayed after the start of the battle game, text or images that indicate all of the plurality of attributes of the specified number of game media included in the deck used by the opponent or one attribute associated with the most game media among the specified number of game media included in the deck used by the opponent.

6. The non-transitory computer readable medium according to claim 1,
wherein the displaying includes displaying, on a pause screen displayed during pausing after the start of the battle game, text or images that indicate the plurality of attributes selected by the user and the plurality of attributes of the predetermined number of game media included in the deck used by the opponent.

7. The non-transitory computer readable medium according to claim 1,
wherein the displaying includes displaying the plurality of attributes selected by the user in such a manner that, for each of the attributes, the magnitude of the number of game media is identifiable, and displaying the plurality of attributes of the specified number of game media included in the deck used by the opponent in such a manner that, for each of the attributes, magnitude of the number of game media is identifiable.

8. A method for providing, to a user, a battle game that uses a deck including a specified number of game media selected from among a plurality of game media each associated with an attribute, the method comprising:
before the start of the battle game, accepting selection of a plurality of attributes of the game media to be included in the deck used in the battle game, the selection being made by the user;
administering the deck such that, for each of the plurality of attributes selected by the user, the number of game media associated with that attribute becomes equal to or larger than a minimum number predetermined for each attribute; and
displaying the plurality of attributes selected by the user and the plurality of attributes of the predetermined number of game media included in the deck used by an opponent that the user plays against.

9. A system for providing, to a user, a battle game that uses a deck including a specified number of game media selected from among a plurality of game media each associated with an attribute, the system comprising:
an accepting processing unit that accepts, before the start of the battle game, selection of a plurality of attributes of the game media to be included in the deck used in the battle game, the selection being made by the user;
an administration processing unit that administers the deck such that, for each of the plurality of attributes selected by the user, the number of game media associated with that attribute becomes equal to or larger than a minimum number predetermined for each attribute; and
a display processing unit that displays the plurality of attributes selected by the user and the plurality of attributes of the predetermined number of game media included in the deck used by an opponent that the user plays against.
